(19) United States
(12) Patent Application Publication
(10) Pub. No.: US 2013/0047488 A1
(43) Pub. Date: Feb. 28, 2013

(54) Fish Traps and Methods of Using the Same

(71) Applicants: Donald L. Hey, Evanston, IL (US); Roy C. Heidinger, Carbondale, IL (US); Robert J. Curran, Gurnee, IL (US)

(72) Inventors: Donald L. Hey, Evanston, IL (US); Roy C. Heidinger, Carbondale, IL (US); Robert J. Curran, Gurnee, IL (US)

(73) Assignee: Donald L. Hey, Evanston, IL (US)

(21) Appl. No.: 13/222,134

(22) Filed: Aug. 31, 2011

(51) Int. Cl. A01K 69/06; A01K 79/00

(52) U.S. Cl. 43/4.5; 43/101

(57) ABSTRACT

Fish traps and methods of using the same are disclosed. A disclosed example fish trap includes a holding chamber having an opening through which a fish may pass, and a bait chamber abutting the holding chamber and separated from the holding chamber by a water permeable barrier.

### FIELD OF THE DISCLOSURE

This disclosure relates generally to trapping fish, and, more particularly, to fish traps and methods of using the same.

### BACKGROUND

In general, a fish trap uses bait to entice fish to enter through an opening in the trap. Once inside the trap, either the fish are unable to find their way out or they are are physically blocked from exiting the trap.

### SUMMARY

Fish traps and methods of using the same are disclosed. A disclosed example fish trap includes a holding chamber having an opening through which a fish may pass, and a bait chamber abutting the holding chamber and separated from the holding chamber by a water permeable barrier.

A disclosed example method of trapping a male fish includes placing an ovulating female fish in a bait chamber of a trap, and positioning the trap in a moving body of water so a holding chamber of the trap for capturing fish is generally down current from the bait chamber, the bait chamber abutting the holding chamber and being separated from the holding chamber by a water permeable barrier.

Another disclosed example fish trap includes a holding chamber having an opening through which a first fish may pass, a bait chamber abutting the holding chamber, the bait chamber containing a second ovulating fish, a water permeable barrier separating the holding chamber and the bait chamber and allowing a pheromone emitted by the second fish to pass through the holding chamber to attract the first fish to enter through the opening in the holding chamber, and a funnel to guide the first fish toward and through the opening, where the fish trap is positioned in a moving body of water oriented so the holding chamber is generally down current from the bait chamber.

The trapped fish can subsequently be removed from the trapped and disposed. For example, the fish may be eaten, relocated and released, or otherwise processed.

### BRIEF DESCRIPTION OF THE DRAWINGS

Features and advantages will become apparent by describing in detail exemplary embodiments with reference to the attached drawings in which:

FIG. 1 is a perspective drawing of an example fish trap, according to one or more aspects of the disclosure;

FIG. 2A is a side view of the example fish trap of FIG. 1;

FIGS. 2B and 2C are top views of the example fish trap of FIG. 1; and

FIG. 2D is an end view of the example fish trap of FIG. 1.

### DETAILED DESCRIPTION

While the examples disclosed herein are particularly useful for trapping carp, the fish traps disclosed herein may be readily modified and/or used to trap other kinds of fish. Moreover, while wire mesh and cable or zip ties are used herein to construct the disclosed fish traps, many additional or alternative water permeable materials and attachment means may be used to construct the disclosed fish traps. For example, one or more exterior surfaces of the disclosed fish traps may be covered in a water impermeable or semi-impermeable transparent material. Furthermore, while dimensions disclosed herein are beneficial for trapping carp, fish traps having other dimensions may be constructed based on the size(s) and type(s) of fish to be trapped, without departing from the spirit of this disclosure. Further still, while the fish traps disclosed herein are rectangular, other shapes (e.g., round, square, hexagonal, multiple funnels, etc.) may be used.

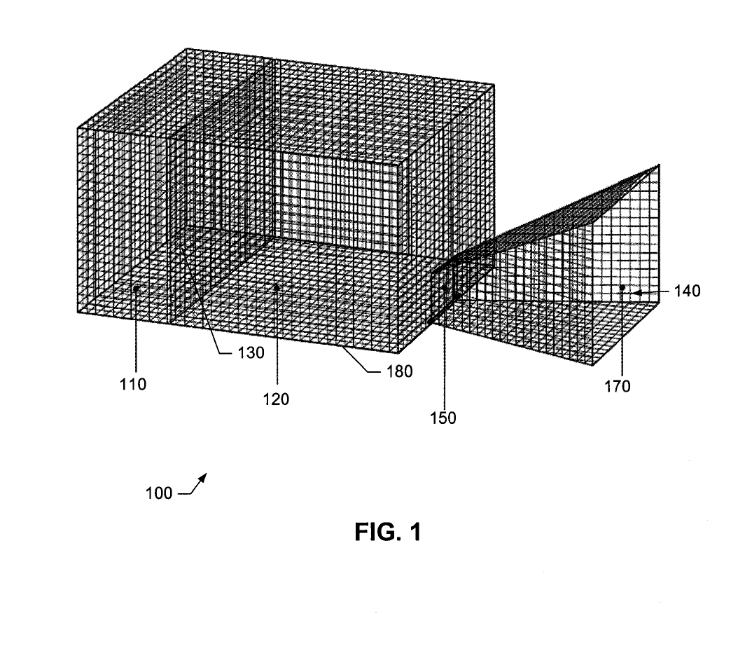

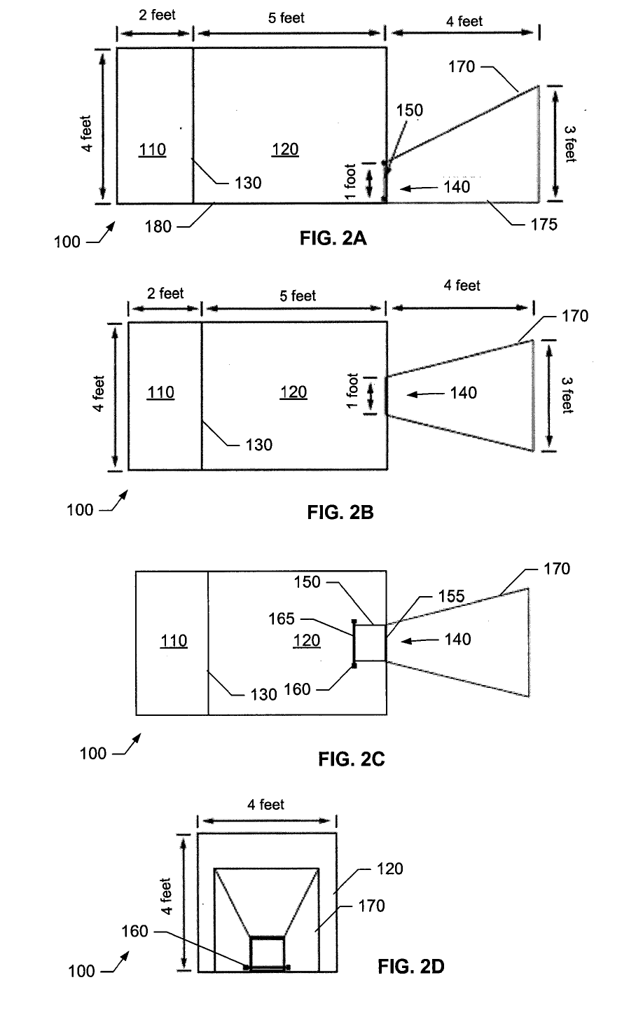

FIG. 1 is a perspective drawing of an example fish trap 100, according to one or more aspects of this disclosure. FIGS. 2A-D are side, top, top, and end views, respectively, of the example fish trap 100 of FIG. 1. Compared to the top view of FIG. 2C, in the top view of FIG. 2D a trap door 150 is open.

Referring to FIGS. 1 and 2A-D, the fish trap 100 includes two abutting chambers 110 and 120 separated by a water permeable barrier 130. The example chamber 110 is a “bait chamber” in which bait such an ovulating female fish, corn, fish food, etc. may be placed. The example chamber 120 is a “holding chamber” in which fish are trapped or held for later removal, consumption or destruction.

The example barrier 130 physically prevents or restricts trapped fish from reaching bait placed in the bait chamber 110. This restriction on fish movement prevents, for example, the bait from being consumed by fish trapped in the holding chamber 120 and, thus, enables the fish trap 100 to be used to efficiently trap more than one fish at a time.

As shown, the holding chamber 120 includes a channel or opening 140 through which fish can move into the holding chamber 120 and become trapped. The channel 120 may be closed off by an inwardly hinged trap door 150 to admit fish through the channel 140 into the holding chamber 120 while preventing fish already in the holding chamber 120 from exiting the holding chamber 120. For example, as a fish enters the holding chamber 120 the trap door 150 swings inwardly along an edge 155, as shown in FIG. 2C, to permit the fish to enter the holding chamber 120. Once the fish has entered the holding chamber 120, the trap door 150 closes. In some examples, the trap door 150 is hinged along the first edge 155 and includes counterweights 160 at an opposite edge 165. A rotational force created by the counterweights 160 causes the trap door 150 to remain generally closed unless a fish is currently entering the holding chamber 120 via the channel 140. The counterweights 160 also prevent movement of trapped fish, movement of the fish trap 100, or currents from inadvertently opening the trap door 150. Alternatively, a spring may be used instead of or in addition to the counterweights 160 to keep the trap door 150 generally closed until opened by incoming fish. Further still, the trap door 150 may be omitted. However, omission of the trap door 150 may allow some trapped fish to exit the holding chamber 120 (i.e., to escape).

As depicted, a funnel or throat 170 may be included to help direct fish attracted by bait in the bait chamber 110 toward the channel 140. The funnel or throat 170 guides fish moving up current toward the fish trap through the channel 140 and past the trap door 150. In other words, as fish are attracted to the scent of bait in the bait chamber 110 moving down current in the body water and, thus, move up current toward the fish trap 100, the funnel 170 guides the fish through the channel 140 and trap door 150 and, thus, into the holding chamber 120. The funnel 170 is preferably wider at an end distal from the fish trap 100 and narrower at the channel 140. When the funnel 170 is wider at the distal end than at the channel 140, fewer fish will bypass the funnel 170 in an attempt to reach the bait.

When the fish trap 100 is used to trap bottom feeding fish such as carp, the funnel 170 may include a bottom wall 175 that is generally coplanar with the bottom wall 180 of the holding chamber 120. Accordingly, when the fish trap 100 is placed on a bottom surface of a body of water, stream, river, etc., the bottom wall 175 of the funnel 170 will rest on or near to the bottom surface, facilitating the entry of bottom feeding fish through the channel 140, past the trap door 150 and into the holding chamber 120. Of course, other arrangements could be used to trap non-bottom feeding fish. For example, weights and/or buoys could be attached to the fish trap 100 to suspend the fish trap 100 at water depths appropriate to the type(s) of fish to be trapped.

Example dimensions of the fish trap 100 are shown in FIGS. 2A-2D. The dimensions shown are beneficial for trapping carp but are not intended to be limiting. For example, the length of the holding chamber 120 (e.g., five feet) is selected to allow a carp to fully pass through the trap door 150 into the holding chamber 120 so the trap door 150 can close behind the carp. Likewise, the bait chamber 110 is dimensioned to hold a female carp.

To use the fish trap 100, bait (e.g., one or more ovulating female fish, corn, fish food, etc.) is placed in the bait chamber 110. The fish trap 100 is then placed in a body of water. The fish trap 100 may, for example, be held it in place with a weight, or a length of line or wire attached to a tree or a stake.

The example fish trap 100 is particularly beneficial in moving bodies of water (e.g., rivers, streams, lakes with currents, etc.) where the fish trap 100 can be oriented so the bait chamber 110 is up current or upstream from the channel 140. In this way, pheromones, smells, particles, etc. of the bait can be carried by the current toward fish. The fish can follow this “bait trail” upstream or up current to the fish trap 100, through the channel 140 where the fish can be subsequently caught in the holding chamber 120.

As described above, fish will be attracted to the bait trail moving generally down current in a body of water and be guided by the funnel 170 into the holding chamber 120. Accordingly, periodically or aperiodically, the fish trap 100 is checked for trapped fish. Trapped fish can be removed by, for example, opening a top, side or end surface of the holding chamber 120. In accordance with wildlife laws, fish trapped in the holding chamber 120 may be kept or released back into the wild. For example, if local fishing laws do not allow the trapping of game fish, any inadvertently or unintentionally trapped game fish are preferably released. However, when a particular species of fish such as carp is being intentionally trapped, the intentionally trapped fish may be destroyed, relocated and released and/or eaten. Because, in the illustrated embodiment, the fish trap 100 is at least partially constructed of a water permeable material such as wire mesh so that aerated and nutrient-containing water can easily move through the fish trap 100, trapped fish are kept alive and fresh (at least for a period of time) in the fish trap 100.

The bait chamber 110 can be used to hold any number and/or type(s) of bait. For example, during carp spawning season, ovulating female carp can be placed in the bait chamber 110, thus allowing for large numbers of male carp to be quickly and efficient trapped. When the fish trap 100 is placed with the bait chamber 100 generally up current or upstream from the holding chamber 120 the strongest trail of the scent emitted by the ovulating female carp will move through the holding chamber 120 and funnel 170. Thus, male fish that are down current from the fish trap 100 will be attracted up current toward the fish trap 100 and be guided by the funnel 140 though the channel 140 and past the trap door 150. Because the male fish will generally follow this strongest scent trail, a majority of the male fish will thus become trapped in the holding chamber 120. Alternatively, during non-spawning season, a human chorionic gonadotropin (HCG) hormone could be used stimulate a female carp to ovulate. Moreover, other types of bait such as corn, fish food, etc. could be used as bait. For example, the bait could be placed in the bait chamber 110 with a trail of bait spread on a bottom surface of a body of water to attract fish toward the fish trap 100.

As shown in FIG. 1, the fish trap 100 may be constructed of panels or pieces of galvanized or painted steel wire mesh held together with cable or zip ties. In some examples, one inch by one inch wire mesh is used. However, other water-permeable materials may be used. Also, hinges, couplings, wire and/or clasps may be used to connect the pieces of wire mesh or other water permeable material(s) that make up the fish trap 100. Moreover, other kinds of wire mesh such as plastic coated wire mesh, chicken wire, etc. may be used to construct the fish trap 100. Further still, one or more exterior surfaces of the fish trap 100 may be covered in a water impermeable or semi-impermeable transparent material. For example, all exterior surfaces of the fish trap 100 may be covered in the water impermeable or semi-impermeable transparent material except for the throat or funnel 170, the door 150, and the end of the fish trap 100 opposite the door 150. Such coverings may be used to, for example, further enhance the flow of scent (e.g., pheromones) out of the funnel 170, thus, further enhancing the effectiveness of the fish trap 100. In other words, the coverings may be used to reduce the flow of scent out of the sides of the fish trap 100.

For the purposes of promoting an understanding of the principles of this disclosure, reference has been made to exemplary embodiments illustrated in the drawings, and specific language has been used to describe these embodiments. However, no limitation of the scope of this disclosure is intended by this specific language, and this disclosure encompasses all embodiments that would normally occur to one of ordinary skill in the art.

The particular implementations shown and described herein are illustrative examples, and do not limit the scope of this disclosure in any way. Moreover, no item or component is essential to the disclosed embodiments unless the element is specifically described as “essential” or “critical”.

The use of the terms “a” and “an” and “the” and similar referents in the context of describing the disclosed embodiments (especially in the context of the following claims) are to be construed to cover both the singular and the plural. Furthermore, any recitation of ranges of values herein is merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as” or “for example”) provided herein, is intended merely to better illuminate the embodiments and does not pose a limitation on the scope of this disclosure unless otherwise claimed. Numerous modifications and adaptations will be readily apparent to those skilled in this art without departing from the spirit and scope of this disclosure.

Although certain example methods, apparatuses and articles of manufacture have been described and disclosed herein, the scope of coverage of any patent resulting from this disclosure is not limited thereto. On the contrary, this disclosure encompasses and covers all methods, apparatuses and articles of manufacture fairly falling within the scope of the appended claims.

1. A fish trap comprising:
a holding chamber having an opening through which a first fish may pass; and
a bait chamber abutting the holding chamber and separated from the holding chamber by a water permeable barrier.

2. A fish trap as defined in claim 1, wherein:
the bait chamber is to hold a second ovulating female fish; and
the water permeable barrier allows a pheromone emitted by the second fish to pass through the holding chamber to attract the first fish to enter through the opening into the holding chamber.

3. A fish trap as defined in claim 2, wherein the water permeable barrier restricts physical contact between the first fish and the second fish.

4. A fish trap as defined in claim 1, wherein, in use, the trap is present in a moving body of water oriented so the holding chamber is generally down current from the bait chamber.

5. A fish trap as defined in claim 1, wherein the holding chamber opening is closed off by a trap door maintained in a closed position by at least one of a counterweight or a spring.

6. A fish trap as defined in claim 5, wherein the trap door allows the first fish to pass through the opening into the holding chamber and prevent the first fish from leaving the holding chamber.

7. (canceled)

8. A fish trap as defined in claim 1, further comprising a funnel to guide the first fish through the opening.

9. A fish trap as defined in claim 8, wherein the funnel is shaped with a narrow end at the opening and a wide end distal from the opening.

10. A fish trap as defined in claim 8, wherein a bottom wall of the funnel is generally coplanar with a bottom wall of the holding chamber.

11. A fish trap as defined in claim 1, wherein the holding chamber, the bait chamber and the water permeable barrier comprise wire mesh.

12. A method of trapping a first fish, the method comprising:
placing bait in a bait chamber of a trap; and
placing the trap in a body of water so a holding chamber of the trap is generally downstream from the bait chamber, the bait chamber abutting the holding chamber and separated from the holding chamber by a water permeable barrier.

13. A method as defined in claim 12, wherein the bait comprises a second ovulating female fish.

14. A method as defined in claim 13, wherein placing the trap so the holding chamber is generally downstream from the bait chamber allows a pheromone emitted by the second fish to pass from the bait chamber through the holding chamber to attract the first fish to enter through an opening in the holding chamber.

15. A method as defined in claim 13, further comprising using a human chorionic gonadotropin hormone to stimulate the second fish to ovulate.

16. A method as defined in claim 12, wherein placing the trap so the holding chamber is generally downstream from the bait chamber allows a scent of the bait to pass from the bait chamber through the holding chamber to attract the first fish to enter through an opening in the holding chamber.

17. A fish trap comprising:
a holding chamber having an opening through which a first fish may pass;
a bait chamber abutting the holding chamber, the bait chamber containing a second ovulating fish;
a water permeable barrier separating the holding chamber and the bait chamber and allowing a pheromone emitted by the second fish to pass through the holding chamber to attract the first fish to enter through the opening in the holding chamber; and
a funnel to guide the first fish toward through the opening.

18. The fish trap as defined in claim 17 positioned in a moving body of water oriented so the holding chamber is generally down current from the bait chamber

19. A fish trap as defined in claim 17, further comprising a trap door closing off the opening and maintained in a generally closed position by at least one of a counterweight or a spring.

20. A fish trap as defined in claim 17, wherein a bottom wall of the funnel is generally coplanar with a bottom wall of the holding chamber.

21. A fish trap as defined in claim 1, wherein at least one surface of the fish trap other than an end of the bait chamber opposite the water permeable barrier and an end of the holding chamber opposite the water permeable barrier comprises a water impermeable material.
